(19) United States
(12) Patent Application Publication
(10) Pub. No.: US 2014/0172540 A1
(43) Pub. Date: Jun. 19, 2014

(54) APPARATUS AND METHOD FOR MEASURING ADVERTISING EFFECT

(71) Applicant: Electronics and Telecommunications Research Institute, Daejeon-si (KR)

(72) Inventors: Hyun-Jin LEE, Daejeon-si (KR); Hwa-Suk KIM, Daejeon-si (KR); Dong-Hun LEE, Daejeon-si (KR); Uk JANG, Daejeon-si (KR); Eun-Il KIM, Seoul (KR)

(73) Assignee: Electronics and Telecommunications Research Institute, Daejeon-si (KR)

(21) Appl. No.: 13/930,954

(22) Filed: Jun. 28, 2013

(30) Foreign Application Priority Data
Dec. 13, 2012 (KR) 10-2012-0145724

(51) Int. Cl. G06Q 30/02

(52) U.S. Cl. CPC G06Q 30/0242
USPC 705/14.41

(57) ABSTRACT

An apparatus for measuring advertising effect includes a content providing unit configured to provide content including one or more advertisements according to a request of one or more fixed terminals, and an effect measuring unit configured to receive an advertisement reproduction/view log from the fixed terminal receiving the content from the content providing unit, and measure the advertising effect in cooperation with another system which provides advertisement-related information or sells an advertised product or service.

### CROSS-REFERENCE TO RELATED APPLICATION

This application claims the benefit under 35 U.S.C. §119(a) of a Korean Patent Application No. 10-2012-0145724, filed on Dec. 13, 2012, in the Korean Intellectual Property Office, the entire disclosure of which is incorporated herein by reference for all purposes.

### BACKGROUND

1. Field

The following description relates to an advertising service providing apparatus and method, and more particularly, to an apparatus and method for measuring the advertising effect of a provided advertisement.

2. Description of the Related Art

In traditional advertising schemes, tangible objects such as a signboard, a leaflet, and a placard are used. In the traditional advertising schemes, it is difficult to specify a target receiver at which advertising is aimed, and a place and manpower are required to expose an advertisement to the target receiver at which the advertising is aimed. However, with the spread of personal computers and the development of communication networks, such as the Internet, an online advertising scheme or an advertising scheme through an electronic terminal using software is regarded to be more efficient than the traditional advertising schemes.

This advertising service is provided through television (TV), Internet protocol TV (IPTV), an outdoor digital signboard, or the like, in the case of a fixed terminal, and provided through a hort message service (SMS), a multimedia message service (MMS), a search engine, or the like, in the case of a mobile terminal.

A set-meter or people-meter for use in a TV or IPTV program rating survey may be utilized in the case of the fixed terminal. However, it is difficult to accurately determine a target who views an advertisement in the case of the set-meter. In the case of the people-meter, there is inconvenience in that an advertisement viewer should input whether to view an advertisement every time through a handset. Also, in the case of the outdoor digital signboard, there is a problem in that it is difficult to measure the advertising effect itself.

### SUMMARY

The following description relates to an apparatus and method for measuring advertising effect by determining whether an advertisement represented on a fixed advertising terminal has been accurately exposed to a user, and determining whether the user viewing the exposed advertisement has accessed advertisement-related content through an information access history of the user.

In one general aspect, there is provided an apparatus for measuring advertising effect, including: a content providing unit configured to provide content including one or more advertisements according to a request of one or more fixed terminals; and an effect measuring unit configured to receive an advertisement reproduction log from the fixed terminal receiving the content from the content providing unit, and measure the advertising effect in cooperation with another system which provides advertisement-related information or sells an advertised product or service.

In another general aspect, there is provided a method of measuring advertising effect, including: providing content including one or more advertisements according to a request of one or more fixed terminals; receiving an advertisement reproduction log from the fixed terminal receiving the content from the content providing unit; and measuring the advertising effect in cooperation with another system which provides advertisement-related information or sells an advertised product or service.

Other features and aspects will be apparent from the following detailed description, the drawings, and the claims.

### BRIEF DESCRIPTION OF THE DRAWINGS

FIG. 1 is a diagram illustrating a system configuration of an advertising effect measuring apparatus according to a first exemplary embodiment of the present invention.

FIG. 2 is a signal flow diagram illustrating an advertising effect measuring method according to the first exemplary embodiment of the present invention.

FIG. 3 is a diagram illustrating a system configuration of an advertising effect measuring apparatus according to a second exemplary embodiment of the present invention.

FIGS. 4 and 5 are signal flow diagrams illustrating an advertising effect measuring method according to the second exemplary embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

According to two exemplary embodiments, advertising effect may be measured.

A first exemplary embodiment is a method of providing an advertising service to a fixed advertising terminal, and measuring the advertising effect.

A second exemplary embodiment is a method of measuring the advertising effect for the advertising service provided to the fixed advertising terminal in association with a mobile terminal.

### First Exemplary Embodiment

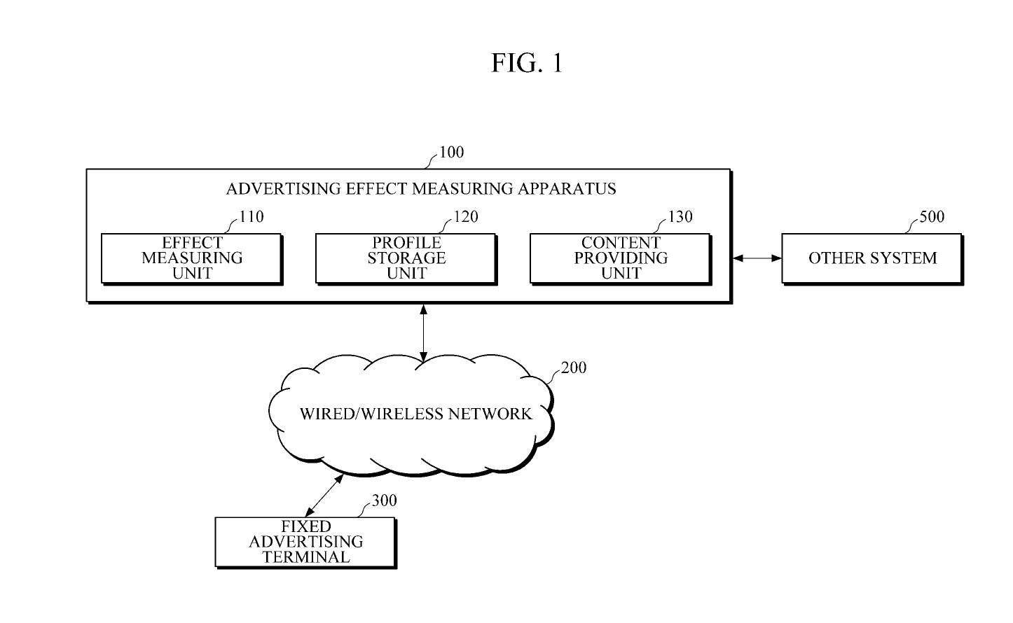

FIG. 1 is a diagram illustrating a system configuration of an advertising effect measuring apparatus according to the first exemplary embodiment of the present invention.

Referring to FIG. 1, the advertising effect measuring apparatus 100 is connected to a fixed advertising terminal 300 through a wired/wireless communication network 200, and performs a function of providing an advertisement to the fixed advertising terminal 300 and measuring the advertising effect of the provided advertisement. In addition, information for measuring the advertising effect for the fixed advertising terminal 300 in cooperation with another system 500 is acquired.

Here, the fixed advertising terminal 300 corresponds to an IPTV set-top box or a cable broadcasting set-top box, and enables a channel broadcast to be viewed when the set-top box functions as a tuner in the case of general public broadcasting/cable broadcasting.

In detail, the advertising effect measuring apparatus 100 includes an effect measuring unit 110, a profile storage unit 120, and a content providing unit 130. Here, although the effect measuring unit 110, the profile storage unit 120, and the content providing unit 130 are included in one apparatus as illustrated, the present invention is not limited thereto. That is, each of the effect measuring unit 110, the profile storage unit 120, and the content providing unit 130 may be configured as a separate server apparatus.

The effect measuring unit 110 measures the advertising effect of an advertisement included in a channel broadcast or video on demand (VOD) content received by the fixed advertising terminal 300. For this, an advertisement reproduction/view log, which is information about the advertisement reproduced from the channel broadcast or the VOD content received by the fixed advertising terminal 300, is received. The advertisement reproduction/view log may include the information about the advertisement reproduced by the fixed advertising terminal 300 and an advertisement reproduction time. For this, the effect measuring unit 110 may pre-download an advertisement reproduction/view log generating module (not illustrated), which generates and transmits the advertisement reproduction/view log, to the fixed advertising terminal 300.

While the channel broadcast or the content is reproduced or when the reproduction ends, the advertisement reproduction/view log generating module generates the advertisement reproduction/view log by extracting exposure information indicating whether the advertisement has been exposed, an advertisement exposure time, an IP address of the fixed advertising terminal 300, information about a user viewing the advertisement, other necessary information, and the like, with respect to each advertisement included in the channel broadcast or the VOD content, and transmits the generated log to the effect measuring unit 110.

In a method of determining whether the advertisement has been viewed, the determination may be made by face recognition through a camera mounted on the set-top box or the like.

Then, the effect measuring unit 110 receives the advertisement reproduction/view log and acquires information for measuring the advertising effect by connecting to the other system 500 which manages an information and sale service providing website related to the advertisement included in the advertisement reproduction/view log. Here, the information for measuring the advertising effect may include advertisement-related content access information and purchase information about an advertised product. In further detail, the advertisement-related content access information may include an advertisement-related content access history or an advertised product or advertisement-related product purchase history through a website which provides an additional information search history related to an advertisement-related term or an advertisement through a search engine and advertisement-related content access information.

The effect measuring unit 110 produces the advertising effect by collecting and analyzing the information for measuring the advertising effect.

As one method in which the effect measuring unit 110 produces the advertising effect, it is first determined whether the user has viewed advertisement content at an advertisement content reproduction time, and it is possible to generate step-by-step advertising effect information indicating a degree of a response of the user exposed to the advertisement by checking whether there is an advertisement-related search history, an advertisement-related content access history, a purchase history, or the like, within a specified time from the reproduction time.

The profile storage unit 120 stores profile information including facial feature information of the user viewing the advertisement through the fixed advertising terminal 300.

The content providing unit 130 provides the fixed advertising terminal 300 with a broadcast or VOD service requested by the user. For this, the content providing unit 130 provides broadcast or content guide information so as to enable the user to select a broadcast or content. Various types of a plurality of advertisements requested by an advertiser may be included in the broadcast or content. The advertisement represented in the broadcast or content may include a word, a keyword, text, and the like, as well as a still image, a moving image, and a flash video.

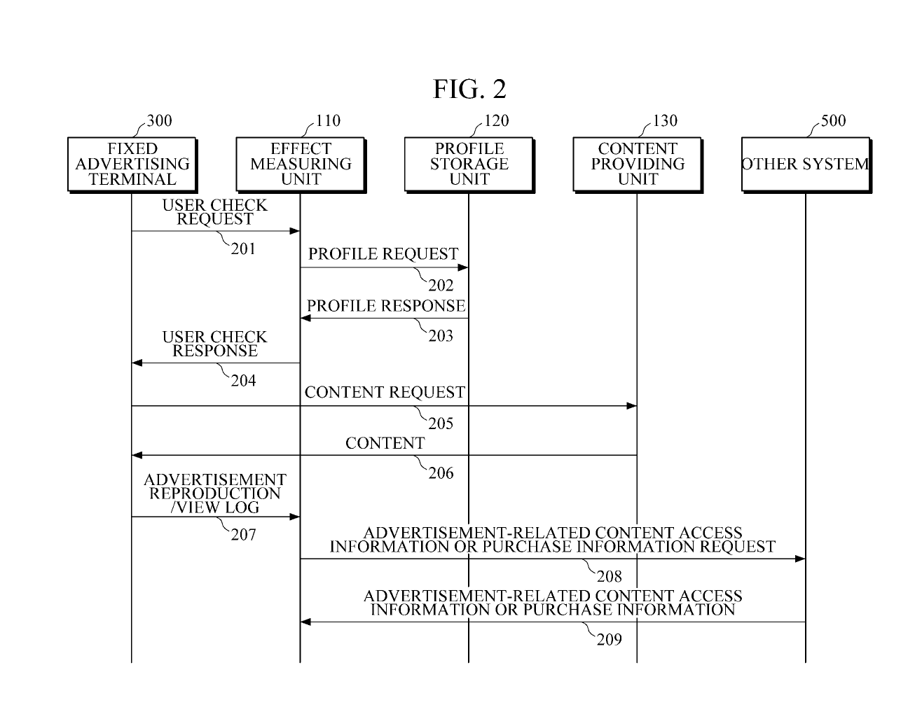

FIG. 2 is a signal flow diagram illustrating an advertising effect measuring method according to the first exemplary embodiment of the present invention.

Referring to FIG. 2, the fixed advertising terminal 300 requests the effect measuring unit 110 to check a user in 201. As information for checking the user, an image obtained through a camera of the fixed advertising terminal 300 is used.

Then, the effect measuring unit 110 requests the profile storage unit 120 to provide a profile corresponding to a viewer of the fixed advertising terminal 300 in 202, receives the profile corresponding to the viewer as a response from the profile storage unit 120 in 203, and checks the viewer of the fixed advertising terminal 300. Here, profile information may include a facial feature of the user, or the like.

The effect measuring unit 110 detects the user's face part from the image received from the fixed advertising terminal 300, and extracts facial feature information from the detected face part. The effect measuring unit 110 determines a user who is viewing an advertisement by comparing the extracted facial feature information to facial feature information acquired from the profile storage unit 120. At this time, because one or more face parts may be detected from the image, the present invention is applicable even when the number of advertisement viewers is large. The effect measuring unit 110 sends a response of a user check result to the fixed advertising terminal 300 in 204.

When the fixed advertising terminal 300 requests the content providing unit 130 to provide a channel broadcast or VOD content in 205, the content providing unit 130 provides the requested channel broadcast or VOD content to the fixed advertising terminal 300 through real-time streaming in 206. For this, the content providing unit 130 provides broadcast or content guide information so as to enable the user to select the broadcast or content. Various types of a plurality of advertisements requested by an advertiser may be included in the broadcast or content. The advertisement represented in the broadcast or content may include a word, a keyword, text, and the like, as well as a still image, a moving image, and a flash video.

While the channel broadcast or the content received by the fixed advertising terminal 300 is reproduced or when the reproduction ends, an advertisement reproduction/view log, which is information about a reproduced advertisement and information about a user viewing the advertisement, is sent to the effect measuring unit 110 in 207. For this, the effect measuring unit 110 may pre-download an advertisement reproduction/view log generating module, which generates and transmits the advertisement reproduction/view log, to the fixed advertising terminal 300. While the channel broadcast or the content is reproduced or when the reproduction ends, the advertisement reproduction/view log generating module generates the advertisement reproduction/view log by extracting exposure information indicating whether an advertisement has been exposed, an advertisement exposure time, an IP address of the fixed advertising terminal 300, user information, other necessary information, and the like, with respect to each advertisement included in the channel broadcast or the VOD content, and transmits the generated log to the effect measuring unit 110.

The effect measuring unit 110 is connected to the other system 500, and requests the other system 500 to provide information about whether viewers have searched advertisement-related addition information through a search engine or the like, information about whether related content has been accessed or the number of related content accesses, and information about whether an advertised product has been purchased in 208.

In addition, the effect measuring unit 110 measures the advertising effect by receiving the advertisement-related content access information or purchase information received as a response in 209.

### Second Exemplary Embodiment

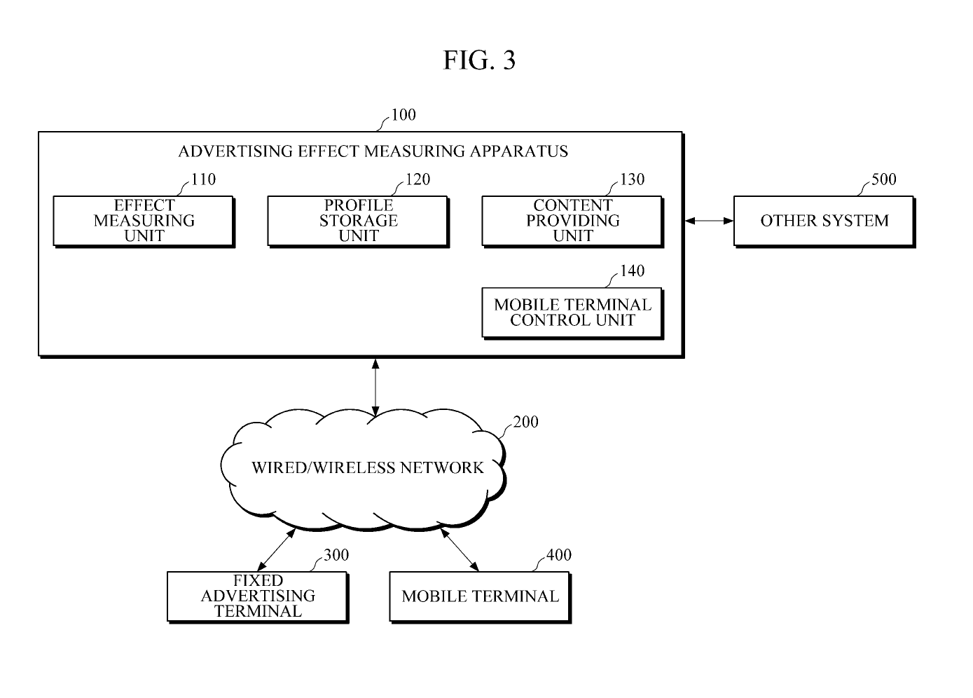

FIG. 3 is a diagram illustrating a system configuration of an advertising effect measuring apparatus according to the second exemplary embodiment of the present invention.

Referring to FIG. 3, the advertising effect measuring apparatus 100 performs a function of providing an advertisement to a fixed advertising terminal 300 through a wired/wireless communication network 200, and measuring the advertising effect of the advertisement provided to the fixed advertising terminal 300 in cooperation with a mobile terminal 400. In addition, information for measuring the advertising effect in cooperation with another system 500 is obtained.

Here, the fixed advertising terminal 300 corresponds to an outdoor digital signage terminal, or the like. The mobile terminal 400 may be a terminal which includes a memory means as in a notebook computer, a personal digital assistant (PDA), a web-pad, a mobile communication terminal, or the like, and may be provided with a microprocessor having arithmetic capability.

In detail, the advertising effect measuring apparatus 100 includes an effect measuring unit 110, a profile storage unit 120, a content providing unit 130, and a mobile terminal control unit 140.

Here, although the effect measuring unit 110, the profile storage unit 120, the content providing unit 130, and the mobile terminal control unit 140 are included in one apparatus as illustrated, the present invention is not limited thereto. That is, each of the effect measuring unit 110, the profile storage unit 120, the content providing unit 130, and the mobile terminal control unit 140 may be configured as a separate server apparatus.

The effect measuring unit 110 measures the advertising effect of the advertisement reproduced by the fixed advertising terminal 300. For this, an advertisement reproduction log, which is information about the advertisement reproduced from the fixed advertising terminal 300, is received. The advertisement reproduction log may include information about the advertisement reproduced in the fixed advertising terminal 300 and an advertisement reproduction time. For this, the effect measuring unit 110 may pre-download an advertisement reproduction log generating module (not illustrated), which generates and transmits the advertisement reproduction log, to the fixed advertising terminal 300.

When content reproduction ends, the advertisement reproduction log generating module generates the advertisement reproduction log by extracting exposure information indicating whether an advertisement has been exposed, an advertisement exposure time, an IP address of the fixed advertising terminal 300, other necessary information, and the like, with respect to each advertisement included in the content, and transmits the generated log to the effect measuring unit 110.

Then, according to reception of the advertisement reproduction log, the effect measuring unit 110 acquires information for advertising effect measurement by connecting to the other system 500 which provides information related to the advertisement or sells an advertised product or service. Here, the user may include advertisement-related content access information and purchase information about an advertised product in the information for the advertising effect measurement through the mobile terminal 400 or the like.

The effect measuring unit 110 produces the advertising effect by collecting and analyzing the information for the advertising effect measurement.

The profile storage unit 120 stores profile information including authentication information for an identification (ID) of the user accessing the mobile terminal 400 or the like. For example, information such as a password, a name, an age, a school career, an address, an occupation, contact information (a mobile phone number, a wired phone number, or the like), or the like for a log-in may be stored in correspondence with an ID number (ID) allocated to the user. In addition, interest and preference information of the user may be included.

The content providing unit 130 provides the fixed advertising terminal 300 with content including an advertisement. Various types of a plurality of advertisements requested by an advertiser may be included in the content. The advertisement may include a word, a keyword, text, and the like, as well as a still image, a moving image, and a flash video.

The mobile terminal control unit 140 authenticates the mobile terminal 400, and transmits position information such as wireless local area network (WLAN) access point (AP) or global positioning system (GPS) information transmitted from the mobile terminal 400 to the effect measuring unit 110. A GPS or WLAN is used to check a position of the mobile terminal 400. Because it is difficult to determine whether the mobile terminal 400 is in a region in which a display of the fixed advertising terminal may be viewed using only one AP in the case of the WLAN, a trigonometric method may be used with at least three APs. The effect measuring unit 110 determines whether the mobile terminal has been exposed to the advertisement from the advertisement reproduction log received from the fixed advertising terminal 300 and mobile terminal position information received from the mobile terminal control unit 140, and is connected to the other system 500 so as to request the other system 500 to provide information about whether viewers have searched advertisement-related addition information through a search engine or the like, information about whether related content has been accessed or the number of related content accesses, and information about whether an advertised product has been purchased in 208. Then, the effect measuring unit 110 measures the advertising effect by receiving advertisement-related content access information or purchase information as a response in 209. Also, the mobile terminal control unit 140 enables advertisement-related content for reproduction in the fixed advertising terminal 300 to be accessed or purchased through the mobile terminal 400. For this, according to a mobile page request from the mobile terminal 400, the mobile terminal control unit 140 checks a position of the mobile terminal 400, acquires schedule information about an advertisement currently being reproduced in the fixed advertising terminal 300 in a region in which the mobile terminal 400 may receive the advertisement, generates a customized mobile page including advertisement-related additional information or related content, and provides the generated customized mobile page to the mobile terminal 400.

In addition, the mobile terminal control unit 140 generates advertisement monitoring log recording whether the mobile terminal 400 has accessed advertisement-related content through the customized mobile page, and transmits the generated advertisement monitoring log to the effect measuring unit 110. Then, the effect measuring unit 120 measures the advertising effect by analyzing the advertisement monitoring log.

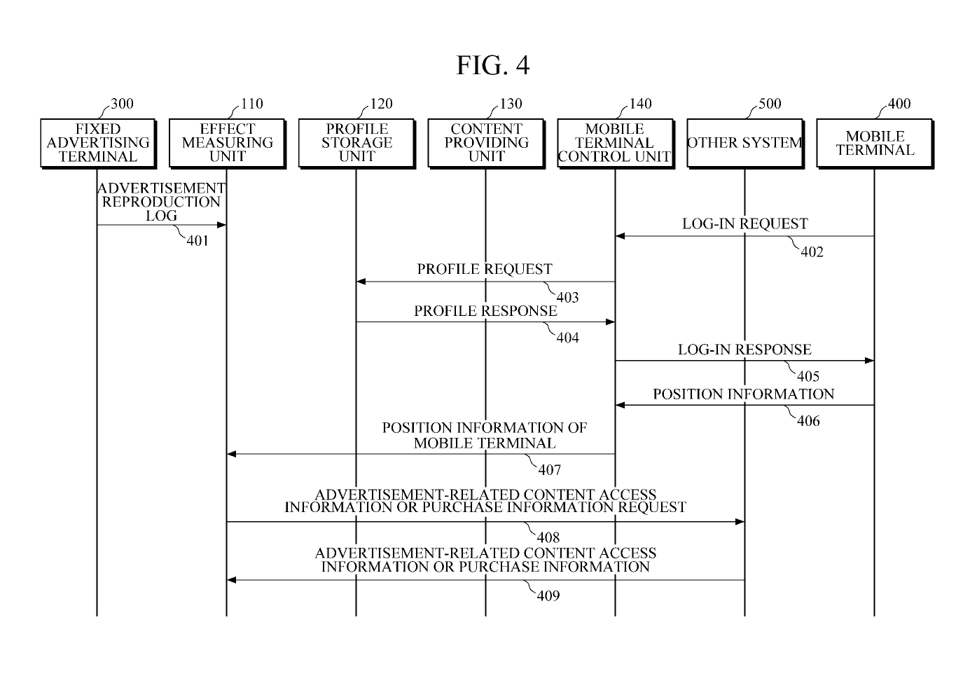

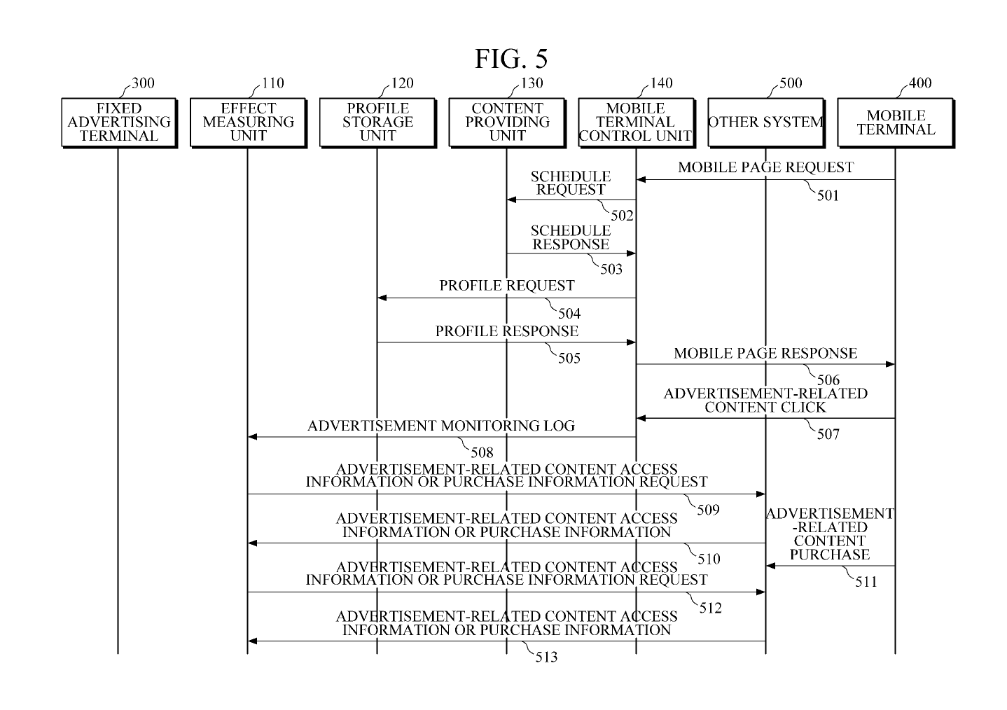

FIGS. 4 and 5 are signal flow diagrams illustrating an advertising effect measuring method according to the second exemplary embodiment of the present invention.

Referring to FIG. 4, the fixed advertising terminal 300 sends advertisement reproduction log, which is information about a reproduced advertisement, to the effect measuring unit 110 while content is reproduced or when the content reproduction ends in 401. For this, the effect measuring unit 110 may pre-download an advertisement reproduction log generating module, which generates and transmits the advertisement reproduction log, to the fixed advertising terminal 300. When content reproduction ends, the advertisement reproduction log generating module generates the advertisement reproduction log by extracting exposure information indicating whether an advertisement has been exposed, an advertisement exposure time, an IP address of the fixed advertising terminal 300, user information, other necessary information, and the like, with respect to each advertisement included in the content, and transmits the generated log to the effect measuring unit 110.

On the other hand, while an advertisement reproduced in the fixed advertising terminal 300 is viewed or after the advertisement has been viewed, the user may access content related to the advertisement viewed using the fixed advertising terminal 300, or perform an advertisement-related content purchase operation.

For this, the mobile terminal 400 sends a log-in request to the mobile terminal control unit 140 in 402. A unique ID of the user is used as information for a log-in. Then, the mobile terminal control unit 140 requests the profile storage unit 120 to provide a profile corresponding to the unique ID of the user in 403, receives the profile corresponding to the unique ID as a response from the profile storage unit 120 in 404, and authenticates the user. Here, information such as a password, a name, an age, a school career, an address, an occupation, contact information (a mobile phone number, a wired phone number, or the like), or the like, for the log-in may be stored as the profile information in correspondence with an ID number (ID)) allocated to the user.

The mobile terminal control unit 140 sends a response of an authentication result to the mobile terminal 400 in 406.

After the user has been authenticated, the mobile terminal transmits position information of the user to the mobile terminal control unit 140 using the WLAN or GPS in 406. The position information is sent to the effect measuring unit 110 in 407. Then, because the effect measuring unit 110 holds the advertisement reproduction log and position information of the mobile terminal and is able to determine whether the user has been exposed to the advertisement, the advertising effect may be produced by acquiring information about whether the user has accessed advertisement-related content or purchased an advertisement-related product from the other system 500 in 408 and 409.

Also, the mobile terminal control unit 140 enables advertisement-related content for reproduction in the fixed advertising terminal 300 to be accessed or purchased through the mobile terminal 400.

For this, according to a mobile page request in 501 from the mobile terminal 400, the mobile terminal control unit 140 requests the content providing unit 130 to provide a schedule about an advertisement currently being reproduced in the fixed advertising terminal 300 in a region in which the mobile terminal 400 may receive the advertisement in 502. Then, the content providing unit 130 collects the schedule about the advertisement currently being reproduced in the fixed advertising terminal 300, and provides the collected schedule to the mobile terminal control unit 140 in 503.

Then, the mobile terminal control unit 140 requests a user profile in 504, and fetches the profile from the profile storage unit in 505. The mobile terminal control unit 140 may generate a customized mobile page including additional information or content related to the advertisement currently being produced in the fixed advertising terminal 300, and provide the generated customized mobile page to the mobile terminal 400 in 506.

Then, the mobile terminal 400 may click on the advertisement-related content through the mobile page in 507. Then, the mobile terminal control unit 140 transmits the advertisement monitoring log recording whether the advertisement-related content has been clicked, to the effect measuring unit 110 in 508.

The effect measuring unit 110 may produce the advertising effect using previously collected advertisement reproduction logs and advertisement monitoring logs. In addition, it is possible to measure the advertising effect by connecting to the other system 500 and acquiring information about whether viewers have retrieved advertisement-related additional information through a search engine or the like, information about whether related content has been accessed or the number of accesses, and information about whether an advertised product has been purchased in 509 and 510. Then, the effect measuring unit 110 may measure the advertising effect according to the purchase in 511 of advertisement-related content using the mobile terminal 400 by periodically performing operations 512 and 513 later. A point in time of the advertisement-related content purchase in 511 illustrated in FIG. 5 is only exemplary and the present invention is not limited thereto.

According to the exemplary embodiments of the present invention, it is possible to provide content or additional information related to an advertisement of a fixed terminal to a mobile page connected through a mobile terminal, and provide the content or additional information in a customized type. In addition, when the user accesses the advertisement-related content or additional information, it is possible to clearly check the advertising effect. Furthermore, there is an advantage in that the target advertising effect may be more accurately determined by checking whether a related product has been purchased.

The present invention can be implemented as computer-readable codes in a computer-readable record medium. Computer-readable record media include all types of record media in which computer-readable data is stored. Examples of computer-readable record media include a ROM, a RAM, a CD-ROM, a magnetic tape, a floppy disk, and an optical data storage. Further, the record medium may be implemented in the form of a carrier wave, such as Internet transmission. In addition, the computer-readable record medium may be distributed to computer systems over a network, in which computer-readable codes may be stored and executed in a distributed manner.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for measuring advertising effect, comprising:
a content providing unit configured to provide content comprising one or more advertisements according to a request of one or more fixed terminals; and
an effect measuring unit configured to receive an advertisement reproduction/view log from the fixed terminal receiving the content from the content providing unit, and measure the advertising effect in cooperation with another system which manages an information and sale service providing website related to the advertisement comprised in the received advertisement reproduction/view log.

2. The apparatus of claim 1, wherein the advertisement reproduction/view log comprises information about the advertisement reproduced in the fixed terminal and an advertisement reproduction time.

3. The apparatus of claim 1, further comprising:
a profile storage unit storing information for checking a user who views advertisement content using the fixed terminal,
wherein the effect measuring unit retrieves a profile from the profile storage unit to check the user according to a user check request of the fixed terminal.

4. The apparatus of claim 1, wherein the effect measuring unit downloads an advertisement reproduction log generating module, which generates and transmits a reproduction log, to the fixed terminal.

5. The apparatus of claim 1, wherein the effect measuring unit acquires advertisement-related content access information or purchase information about an advertised product from the other system.

6. The apparatus of claim 1, further comprising:
a mobile terminal control unit configured to generate a customized mobile page comprising additional information or content related to the advertisement currently being reproduced in the fixed terminal according to a mobile page request from a mobile terminal, and provide the generated customized mobile page to the mobile terminal.

7. The apparatus of claim 6, wherein, when the mobile page is requested, the mobile terminal control unit checks a position of the mobile terminal, acquires schedule information about content currently being reproduced in the fixed terminal in a region in which the mobile terminal may receive the advertisement, and generates the customized mobile page according to the acquired schedule information.

8. The apparatus of claim 6,
wherein the mobile terminal control unit generates an advertisement monitoring log recording whether the mobile terminal has accessed advertisement-related content through the customized mobile page, and transmits the generated advertisement monitoring log to the effect measuring unit, and
wherein the effect measuring unit measures the advertising effect by analyzing the advertisement monitoring log.

9. The apparatus of claim 6, wherein the effect measuring unit measures the advertising effect by connecting to the other system and acquiring at least one of information about whether a user has retrieved advertisement-related additional information using the fixed terminal or the mobile terminal, information about whether related content has been accessed or the number of accesses, and information about whether an advertised product has been purchased.

10. A method of measuring advertising effect, comprising:
providing content comprising one or more advertisements according to a request of one or more fixed terminals;
receiving an advertisement reproduction/view log from the fixed terminal receiving the content; and
measuring the advertising effect in cooperation with another system which manages an information and sale service providing website related to the advertisement comprised in the received advertisement reproduction/view log.

11. The method of claim 10, further comprising:
performing a user check by retrieving a profile from a profile storage unit according to a user check request of the fixed terminal before the content is provided.

12. The method of claim 10, wherein the measuring comprises:
acquiring advertisement-related content access information or purchase information about an advertised product from the other system; and
measuring the advertising effect by analyzing the acquired information.

13. The method of claim 10, further comprising:
receiving a mobile page request from a mobile terminal;
generating a customized mobile page comprising additional information or content elated to an advertisement currently being reproduced in the fixed terminal; and
providing the generated customized mobile page to the mobile terminal.

14. The method of claim 13, further comprising:
checking a position of the mobile terminal when the customized mobile page is requested; and
acquiring schedule information about the content currently being reproduced in the fixed terminal in a region in which the mobile terminal may receive the advertisement,
wherein the generating comprises:
generating the customized mobile page according to the acquired schedule information.

15. The method of claim 14, wherein the measuring comprises:
measuring the advertising effect by analyzing the advertisement monitoring log recording whether the mobile terminal has accessed advertisement-related content through the customized mobile page.

16. The method of claim 14, wherein the measuring comprises:
measuring the advertising effect by connecting to the other system and acquiring at least one of information about whether the fixed terminal or the mobile terminal has retrieved advertisement-related additional information, information about whether related content has been accessed or the number of accesses, and information about whether an advertised product has been purchased.
